(19) United States
(12) Patent Application Publication
(10) Pub. No.: US 2025/0284870 A1
(43) Pub. Date: Sep. 11, 2025

(54) METHOD AND SYSTEM FOR DESIGNING INTEGRATED CIRCUITS

(71) Applicant: Samsung Electronics Co., Ltd., Suwon-si (KR)

(72) Inventors: Myeongjae Song, Suwon si (KR); Sungcheol Park, Suwon-si (KR)

(73) Assignee: Samsung Electronics Co., Ltd., Suwon-si (KR)

(21) Appl. No.: 18/938,903

(22) Filed: Nov. 6, 2024

(30) Foreign Application Priority Data
Mar. 6, 2024 (KR) 10-2024-0032241

(51) Int. Cl. G06F 30/327; G06F 30/3315; G06F 119/12

(52) U.S. Cl. CPC G06F 30/327; G06F 30/3315; G06F 2119/12

(57) ABSTRACT

Provided are a method and system for designing an integrated circuit. The method of designing an integrated circuit by using a computing system includes selecting a memory combination from among a memory candidate group, generating timing information data of the selected memory combination, generating first result data by performing a first pre-timing analysis module based on the timing information data, determining whether the first result data satisfies a first timing condition, and when the first result data satisfies the first timing condition, generating synthesized data by synthesizing the integrated circuit.

### CROSS-REFERENCE TO RELATED APPLICATION

This application is based on and claims ranking under 35 U.S.C. § 119 to Korean Patent Application No. 10-2024-0032241, filed on Mar. 6, 2024 in the Korean Intellectual Property office, the disclosure of which is incorporated by reference herein in its entirety.

### BACKGROUND

The inventive concept relates to a method of designing an integrated circuit, and more particularly, to a method and system for designing an integrated circuit by efficiently selecting a memory constituting the integrated circuit at an early stage.

As the semiconductor industry becomes more complex and diversified, the demand for not only standard integrated circuits (IC) manufactured according to defined standards but also application specific integrated circuits (ASICs) manufactured for particular purposes required by consumers such as fabless ICs is also increasing.

In a process of designing and manufacturing an IC which meets the needs of consumers, the performance, power, size, or the like of a product may vary depending on the configuration of the memory constituting an IC. In addition, ICs such as artificial intelligence (AI) ICs due to the increased demand for AI may have a high proportion of memory, and the specifications of a product may be greatly affected depending on the construction of the memory. Thus, a method of determining the configuration of a memory constituting an IC within a limited development schedule of an ASIC becomes important.

### SUMMARY

The inventive concept provides a method and system for designing an integrated circuit by quickly and efficiently selecting a memory constituting an integrated circuit.

According to an aspect of the inventive concept, there is provided a method of designing an integrated circuit by using a computing system including selecting a memory combination from among a memory candidate group, generating timing information data of the selected memory combination, generating first result data by performing a first pre-timing analysis module based on the timing information data, determining whether the first result data satisfies a first timing condition, and when the first result data satisfies the first timing condition, generating synthesized data by synthesizing the integrated circuit.

According to another aspect of the inventive concept, there is provided a system of designing an integrated circuit including at least one processor, and a non-transitory storage medium for storing instructions, which when executed by the at least one processor, cause the at least one processor to execute designing an integrated circuit, wherein the designing of the integrated circuit includes selecting a memory combination from among a memory candidate group, generating timing information data of the selected memory combination, generating first result data by performing a first pre-timing analysis module based on the timing information data, determining whether the first result data satisfies a first timing condition, and when the first result data satisfies the first timing condition, generating synthesized data by synthesizing the integrated circuit.

According to another aspect of the inventive concept, there is provided a non-transitory storage medium for storing instructions, which when executed by the at least one processor, cause the at least one processor to execute designing an integrated circuit, wherein the designing of the integrated circuit includes selecting a memory combination from among a memory candidate group, generating timing information data of the selected memory combination, generating first result data by performing a first pre-timing analysis module based on the timing information data, determining whether the first result data satisfies a first timing condition, and when the first result data satisfies the first timing condition, generating synthesized data by synthesizing the integrated circuit.

### BRIEF DESCRIPTION OF THE DRAWINGS

Embodiments will be more clearly understood from the following detailed description taken in conjunction with the accompanying drawings in which:

FIG. 1 is a flowchart of a design process of an integrated circuit, according to an embodiment;

FIG. 2 is a block diagram of a circuit design system according to an embodiment;

FIG. 3 is a block diagram of a circuit design system according to an embodiment;

FIG. 4 is a flowchart of a method of designing an integrated circuit, according to an embodiment;

FIG. 5 is a flowchart of a method of designing an integrated circuit, according to an embodiment;

FIG. 6 is a flowchart of a method of designing an integrated circuit, according to an embodiment;

FIG. 7 is a flowchart of a method of designing an integrated circuit, according to an embodiment;

FIGS. 8A and 8B are block diagrams of integrated circuits manufactured according to synthetic data, according to an embodiment;

FIG. 9 is a block diagram of a computing system including memories for storing programs according to an embodiment; and

FIG. 10 is a block diagram of a computer system accessing a computer-readable storage medium according to an embodiment.

### DETAILED DESCRIPTION OF THE EMBODIMENTS

Hereinafter, embodiments of the inventive concept will be described in detail with reference to the accompanying drawings.

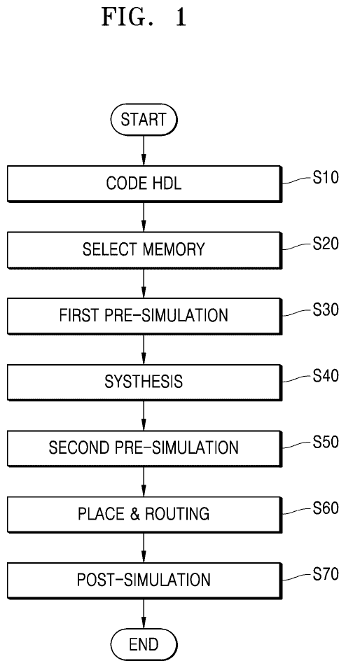

FIG. 1 is a flowchart of a design process of an integrated circuit, according to an embodiment.

Referring to FIG. 1, a method of designing an integrated circuit is an operation of designing a layout for the integrated circuit, and may be performed by using a tool for designing an integrated circuit. The method of designing an integrated circuit may be performed prior to a manufacturing process of an integrated circuit. In this case, the tool for designing an integrated circuit may include a program including a plurality of commands to be executed by a processor. Accordingly, the method of designing an integrated circuit may be referred to as a computer-implemented method for designing an integrated circuit. The tool for designing an integrated circuit may include electronic design automation (EDA). For convenience of description, in the inventive concept, a tool, a computing device, or the like for designing an integrated circuit are collectively referred to as a circuit design system.

The design process of an integrated circuit may be largely classified into a front-end design and a back-end design. The front-end design may include a process of designing a logical operation to be performed by an integrated circuit, and may be referred to as a logic design or a digital design. The front-end design according to an embodiment may be performed by a fabless company. The back-end design may include a process to proceed after the front-end design, and may perform the layout design by using a computer-aided design (CAD) program, etc. The back-end design may design a layout to be drawn on a wafer or a layout of a printed circuit board (PCB) substrate. The back-end design according to an example may be performed by a design house company. After the design process of an integrated circuit is performed, the manufacturing process of an integrated circuit may be subsequently performed.

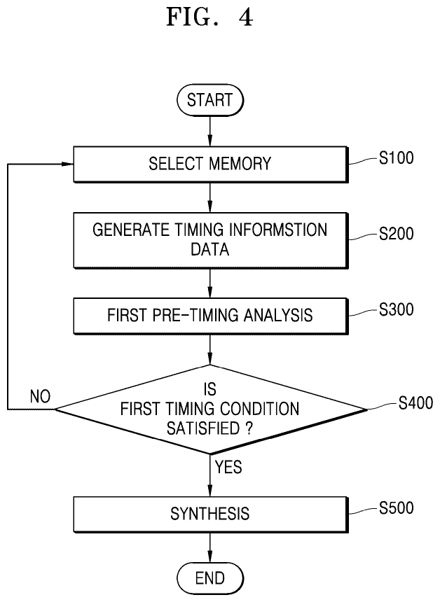

Referring to FIG. 1, the design process of an integrated circuit may include a plurality of operations S10 through S70. The circuit design system may implement at least a portion of the design process of an integrated circuit by performing a method of designing an integrated circuit. In other words, the method of designing an integrated circuit may include at least some of the plurality of operations S10 through S70, and the design process of an integrated circuit may be performed by a plurality of subjects. For example, a fabless company and a design house company may collaborate to perform the design process of an integrated circuit. Operations S10 through S50 may include the front-end design, and operations S60 through S70 may include the back-end design. Detailed embodiments of the method of designing an integrated circuit are described below with reference to FIGS. 4 through 7.

In operation S10, the circuit design system may generate hardware description language (HDL) code by executing HDL code. The HDL code may include code describing a circuit to be implemented in functional units by using a hardware language, and HDL coding may also be referred to as register-transistor level (RTL) coding. The HDL code according to an embodiment may be implemented by using a language, such as a Verilog and a very-high-speed integrated circuit (VHSIC) hardware description language (HDL) (VHDL). In operation S10, a functional verification on the HDL code may be additionally performed. The functional verification may include a process of verifying whether the HDL code is implemented as a circuit to be implemented. Operation S10 may also be performed outside. In other words, the circuit design system may also perform operation S20 by receiving the HDL code generated outside.

In operation S20, the circuit design system may select a memory constituting an integrated circuit from a memory candidate group. A memory may include a volatile memory, such as static random access memory (RAM) (SRAM) and dynamic RAM (DRAM), and a non-volatile memory, such as phase change RAM (PRAM), magnetic RAM (MRAM), resistive RAM (ReRAM), ferroelectric RAM (FRAM), and NOR flash memory. The memory of an integrated circuit to be implemented may be selected from a memory candidate group including various types of memory devices. An integrated circuit may include a plurality of memories. In other words, the circuit design system may select a memory to constitute an integrated circuit from a memory candidate group. An integrated circuit may include one or more memories, but the description of a memory constituting an integrated circuit may not inevitably imply that an integrated circuit includes only one memory, and thus, the number of memories constituting an integrated circuit is not limited to only one.

In a process of designing an integrated circuit, the performance, power, size, or the like of a product may vary depending on the configurations of memories constituting an integrated circuit. In addition, an integrated circuit such as an artificial intelligence (AI) integrated circuit due to the increased demand for AI may have a high proportion of memory, and the specification of a product may be greatly affected by how a memory is configured. Accordingly, it may be required to implement memories, by properly selecting memories, such that the power or size of an integrated circuit is not increased more than necessary while an integrated circuit normally operates.

In operation S30, the circuit design system may perform a first pre-simulation on an integrated circuit after selecting a memory in operation S20. The first pre-simulation may be referred to as a simulation for inspection prior to synthesis of an integrated circuit, based on the HDL code and a database of the selected memory. The simulation according to the embodiment may include a timing analysis, and may include a static timing analysis (STA). The STA may not evaluate changes in values of flip-flops according to time flow, but may analyze data change between flip-flops in a pre-defined time (for example, one clock period). The circuit design system according to the embodiment of the inventive concept may check in advance whether the integrated circuit malfunctions by using a first pre-simulation that performs the timing analysis before synthesis of the integrated circuit.

For a normal operation of the integrated circuit, the memory may satisfy the timing specification. For example, the minimum operation period or minimum operation timing of a clock, to which the memory operates, may need to have values greater than or equal to a required timing for a normal operation of the integrated circuit. Hereinafter, an upper bound value of the timing required to normally perform a function to be implemented may be referred to as a timing threshold. In addition, the minimum operation period or minimum operation timing may be referred to as an operation timing or a timing for convenience of description.

When the operation timing of a memory is equal to or greater than the timing threshold, in theory, the memory may operate normally. However, in the design process and the manufacturing process, distortion in an operation period of a memory may occur due to various variables, such as crosstalk, jitter, skew, impedance mismatch, leakage current, variation in a read time and a write time, and degradation due to product use. Additionally, distortion of the operation period of a memory may occur due to variables, such as a placement and routing (PnR) method and a fabrication method of the integrated circuit. Accordingly, the operation timing of the memory may be required to be adjusted considering the variables described above so that the operation timing has a value of the timing threshold or greater. In other words, a timing margin reflecting the various variables additionally described above to the timing threshold may be considered. Hereinafter, for convenience of description, the various variables described above capable of causing distortion in the operation period may be collectively referred to as timing variables.

When the first pre-timing analysis is not performed, the design process of an integrated circuit may perform an initial timing analysis after synthesis of an integrated circuit. When a result of the timing analysis after synthesis shows that timing conditions has not been satisfied, the timing analysis may need to be performed again after a new memory selection and a new synthesis process. Accordingly, to determine the final design of the integrated circuit within a limited time, it may be necessary to conservatively select a timing margin reflecting various timing variables in the design process of the integrated circuit in which the first pre-timing analysis has not been performed. In other words, by selecting the timing margin reflecting various timing variables as proper values, the memory selection may be performed. As the conservative timing margin is considered, the types of selectable memories in the memory selection operation may be reduced. Thus, in the design process of an integrated circuit, on which the first pre-timing analysis has not been performed, an integrated circuit may be designed by selecting a memory from among a group of memory candidates having a relatively limited option.

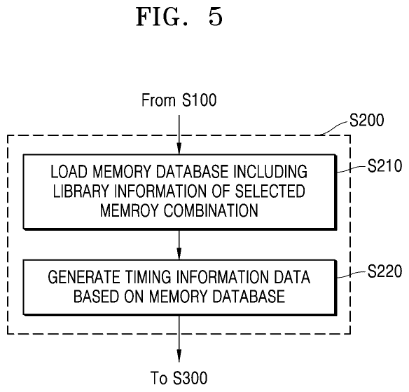

The circuit design system according to an embodiment of the inventive concept may perform additional timing analysis in advance prior to the synthesis of an integrated circuit. In other words, the circuit design system according to an embodiment of the inventive concept may perform the initial timing analysis prior to the synthesis of an integrated circuit. The timing analysis performed prior to the synthesis of an integrated circuit may be referred to as the first pre-timing analysis, and a timing analysis performed after the synthesis of an integrated circuit may be referred to as a second pre-timing analysis. The circuit analysis system according to an embodiment may perform the first pre-timing analysis in operation S30. The circuit design system according to an embodiment may perform the first pre-timing analysis prior to the synthesis of an integrated circuit. Accordingly, when the timing condition is not satisfied as a result of timing analysis, the timing analysis may be performed again quickly. In addition, because quick repetition is possible, the final design of an integrated circuit may be completed within a limited time even though the timing margin reflecting various timing variables is not conservatively selected. In other words, without selecting the timing margin reflecting various timing variables as unnecessarily large values, the memory selection may be performed. As the timing margin of a proper value is considered, the types of memory selectable in the memory selection operation may increase compared to the case in which the first pre-timing analysis has not been performed. Thus, in the integrated circuit design process according to an embodiment, an integrated circuit may be designed by selecting a memory from among the memory candidate group having a relatively flexible option. A detailed method of the first pre-timing analysis is described below with reference to FIGS. 4 and 5.

In operation S40, the circuit design system may generate synthesized data by synthesizing the integrated circuit. The circuit design system may perform a synthesis process of connecting logical structures based on the HDL code and the database of the selected memory. The circuit design system may generate synthesized data by synthesizing the HDL code with the database of the selected memory. The synthesized data according to an embodiment may include a gate level netlist.

In operation S50, the circuit design system may perform a second pre-simulation on the integrated circuit. The second pre-simulation may be referred to as a simulation that checks after synthesis of an integrated circuit based on the synthesized data generated as a result of synthesis. The simulation according to an embodiment may include the timing analysis and may include the STA. The design process of an integrated circuit, in which the first pre-timing analysis has not been performed, may perform the initial timing analysis after synthesis of an integrated circuit. In other words, without performing the first pre-simulation, the second pre-simulation may be performed for the first time after synthesis. The circuit design system according to the embodiment of the inventive concept may check in advance whether the integrated circuit malfunctions by using the first pre-simulation that performs the timing analysis before synthesis of the integrated circuit. In addition, the circuit design system may check whether the integrated circuit malfunctions by performing the second pre-simulation after synthesis of the integrated circuit.

In operation S60, the circuit design system may perform the PnR process of an integrated circuit. The circuit design system may implement a layout by arranging actual devices and connecting wirings, based on the synthesized data that has undergone the second pre-simulation. The layout to be implemented may be implemented in three dimensions (3D). The PnR process may include designing of a layout to be drawn on a wafer or a layout of a PCB substrate. Operation S60 may also be performed outside. For example, operation S60 may also be performed by a company such as a design house. The layout data may be generated as a result of the PnR process. The layout data according to an embodiment may include a graphic design system (GDS) file.

In operation S70, the circuit design system may perform a post-simulation on the integrated circuit. The post-simulation may be referred to as a simulation that checks after the PnR process of an integrated circuit, based on the layout data generated as a result of the PnR process. The simulation according to an embodiment may include the timing analysis. Apart from the pre-simulation performed in the front-end design operation, the simulation performed on the layout data generated in the back-end design operation may be referred to as the post-simulation. The circuit design system according to an embodiment may perform a post-timing analysis in operation S70. Duplicate descriptions of the timing analysis described above are omitted. Operation S70 may also be performed outside. For example, operation S70 may also be performed by a company such as a design house.

Subsequent to operation S70, a semiconductor fabrication process may be performed. The semiconductor manufacturing process may be referred to as a process of manufacturing an actual semiconductor chip based on the designed layout data. The semiconductor manufacturing process according to an embodiment may be performed by a company such as a foundry.

According to the embodiments described above, by additionally performing the pre-timing analysis prior to the synthesis of an integrated circuit, it may be possible to design an integrated circuit by quickly and efficiently selecting memories constituting the integrated circuit. In addition, by performing the timing analysis quickly and efficiently in the memory selection operation prior to the synthesis of the integrated circuit, unnecessary timing margins may be reduced, and the performance of the integrated circuit may be increased by using quick feedback, and the development time may be shortened.

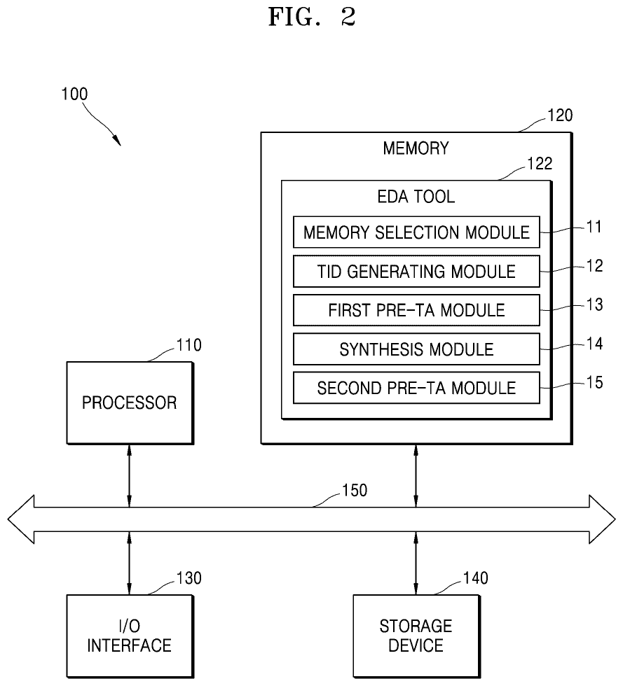

FIG. 2 is a block diagram of a circuit design system 100 according to an embodiment.

Referring to FIG. 2, the circuit design system 100 may include a processor 110, a memory 120, an input/output (I/O) interface 130, a storage device 140, and a bus 150. In this case, the circuit design system 100 may be an example of the circuit design system described above with reference to FIG. 1. Hereinafter, FIG. 2 is described with reference to FIG. 1 described above, and duplicate descriptions thereof are omitted.

The processor 110 may execute software (application programs, operating systems, device drivers, modules, or the like) to be executed by the integrated circuit design system 100. For example, the processor 110 may execute an operating system (OS) loaded into the memory 120. The processor 110 may execute various application programs or design tools to be driven in the OS. For example, the processor 110 may include at least one core capable of executing an arbitrary command set (for example, Intel Architecture-32 (IA-32), 64-bit expansion IA-32, x86-64, PowerPC, Sparc, microprocessor without interlocked pipeline stages (MIPS), advanced RISC machine (ARM), IA-64, or the like), such as a micro-processor, an application processor (AP), a digital signal processor (DSP), and a graphics processing unit (GPU). In some embodiments, the processor 110 may be configured to execute instructions performing at least one of various operations for designing a circuit. For example, the processor 110 may drive design tools of the semiconductor device loaded in the memory 120. For example, the EDA tool 122 provided as a design tool may be loaded into the memory 120 and driven by the processor 110. The processor 110 may perform an integrated circuit design operation by driving the EDA tool 122, that is, a memory selection module 11, a timing information data (TID) generating module 12, a first pre-timing analysis (TA) module 13, a synthesis module 14, and a second pre-TA module 15. Although not illustrated, the processor 110 may further drive other various modules for designing a circuit.

The term ‘module’ used in the modules described above and below may mean software or hardware components, such as a field programmable gate array (FPGA) and an application specific integrated circuit (ASIC), and the ‘module’ may perform a certain role. However, the meaning of the ‘module’ is not limited to software or hardware. The ‘module’ may be configured to reside in an addressable storage medium, and may be configured to play back one or more processors. Accordingly, the ‘module’ may include, for example, components, such as software components, object-oriented software components, class components, and task components, processes, functions, procedures, sub-routines, segments of program code, drivers, firmware, microcode, circuits, data, databases, data structures, tables, arrays, and variables. Functions provided in the components and the ‘module’s may be combined into a smaller number of components and ‘module’s, or may be further separated into additional components and ‘module’s.

The method of designing an integrated circuit according to an embodiment may be applied to the EDA tool 122 and/or a plurality of modules (that is, 11 through 15) and may be executed. However, the inventive concept is not limited thereto. In other words, at least one of the plurality of modules (i.e., 11 through 15) according to an embodiment may be arranged outside the EDA tool 122, and may be provided as a separate module or a separate tool.

The OS or application programs may be loaded in the working memory 120. At the time of booting the circuit design system 100, an image of the OS stored in the storage device 140 may be loaded in the memory 120 according to a booting sequence. All I/O operations of the circuit design system 100 may be supported by the OS. Similarly, the application programs (for example, the EDA tool 122) selected by a user or for providing a basic service may be loaded in the memory 120.

In some embodiments, as described above, the memory 120 may store the memory selection module 11, the TID generation module 12, the first pre-TA module 13, the synthesis module 14, and the second pre-TA module 15. The plurality of modules (that is, 11 through 15) may be loaded from the storage device 140 to the memory 120. For example, the memory selection module 11 may include a program including a plurality of instructions for performing the memory selection according to operation S20 in FIG. 1. The TID generating module 12 may include a program including a plurality of instructions for generating the TID, which is base data for performing the first pre-timing analysis according to operation S30 in FIG. 1. The TID may include timing information about an integrated circuit of the selected memory, and may include base data of the first pre-TA. The TID may include a netlist of the selected memory and timing constraints. In addition, the first pre-TA module 13 may include a program including a plurality of instructions for performing the first pre-TA according to operation S30 in FIG. 1. The synthesis module 14 may include a program including a plurality of instructions for performing the synthesis operation according to operation S40 in FIG. 1. The second pre-TA module 15 may include a program including a plurality of instructions for performing the second pre-TA according to operation S50 in FIG. 1.

The memory 120 may include a volatile memory, such as SRAM and DRAM, and a non-volatile memory, such as PRAM, MRAM, ReRAM, FRAM, and flash memory.

The EDA tool 122 may load the plurality of modules (that is, 11 through 15) to perform the method of designing an integrated circuit described above with reference to FIG. 1. The EDA tool 122 may select a memory or a memory combination constituting an integrated circuit from among a memory candidate group, and may perform the first pre-TA and the second pre-TA. In addition, the EDA tool 122 may perform an operation of synthesizing an integrated circuit, and a PnR operation. The EDA tool 122 may perform an operation of designing an integrated circuit by quickly and efficiently selecting memories constituting the integrated circuit by using the method of designing an integrated circuit according to an embodiment of the inventive concept.

The I/O interface 130 may control user inputs and outputs to and from user interface devices. For example, the I/O interface 130 may include an input device, such as a keyboard, a mouse, and a touch pad, and may receive a netlist file of a semiconductor device or configuration information about various standard cells. In addition, the I/O interface 130 may be equipped with an output device such as a monitor, and display progress and processing results of the design operation of the circuit design system 100.

The storage device 140 may be provided as a storage medium of the circuit design system 100. The storage device 140 may store application programs, OS images, and various types of data. For example, the storage device 140 may store various data related to the plurality of modules (that is, 11 through 15). For example, the storage device 140 may store timing data, synthesized data, layout data, selected memory combinations, or the like that is generated as results of the operation of the EDA tool 122. The storage device 140 may also be provided as a memory card (for example, a multi-media card (MMC), an embedded MMC (eMMC), a secure digital (SD) card, a MicroSD card, or the like), or a hard disk drive (HDD). The storage device 140 may include a NAND-type flash memory having a large storage capacity. Alternatively, the storage device 140 may also include a next generation non-volatile memory, such as PRAM, MRAM, ReRAM, FRAM, or NOR flash memory.

The bus 150 may be provided as an interconnector for providing a network inside the circuit design system 100. The processor 110, the memory 120, the I/O interface 130, and the storage device 140 may be electrically connected to each other and interchange data via the bus 150. However, a configuration of the bus 150 is not limited to descriptions given above, and may further include arbitration components for efficient management.

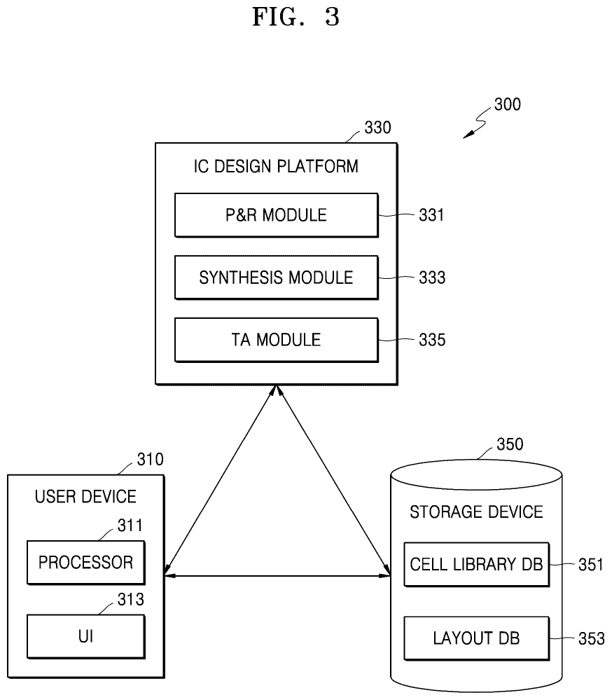

FIG. 3 is a block diagram of a circuit design system 300 according to an embodiment.

Referring to FIG. 3, the integrated circuit design system 300 may include a user device 310, an integrated circuit design platform 330, and a storage device 350. The integrated circuit design system 300 may perform, for example, an integrated circuit design operation including the plurality of operations S10 through S70 in FIG. 1. The integrated circuit design system 300 may also perform the integrated circuit design operation including some operations in FIG. 1, for example, operations S20 though S40. In addition, in the embodiment, at least one of the user device 310, the integrated circuit design platform 330, and the storage device 350 may include a separate device, and the user device 310, the integrated circuit design platform 330, and the storage device 350 may be connected to each other via wired or wireless communication or a network. In an embodiment, at least one of the user device 310, the integrated circuit design platform 330, and the storage device 350 may be apart from other components.

The user device 310 may include a processor 311 and a user interface (UI) 313. According to a user's input with a user input device via the UI 313, the processor 311 may drive the integrated circuit design platform 330. The processor 311 may include at least one core capable of executing an arbitrary command set (for example, Intel Architecture-32 (IA-32), 64-bit expansion IA-32, x86-64, PowerPC, Sparc, microprocessor without interlocked pipeline stages (MIPS), advanced RISC machine (ARM), IA-64, or the like), such as a micro-processor, an AP, a DSP, and a GPU.

The integrated circuit design platform 330 may include a set of computer-readable instructions for designing an integrated circuit, and may include a place & routing (P&R) module 331, a synthesis module 333, and a TA module 335. The P&R module 331 may include a program including a plurality of instructions for performing the P&R operation according to operation S60 in FIG. 1, and may be omitted depending on the case. The synthesis module 333 may correspond to the synthesis module 14 in FIG. 2. The TA module 335 may perform the TA, and may correspond to the first pre-TA module 13 and the second pre-TA module 15 in FIG. 2. Additionally, the integrated circuit design platform 330 may include the memory selection module and the TID generation module. The memory selection module and the TID generation module may correspond to the memory selection module 11 and the TID generation module 12 in FIG. 2, respectively.

The storage device 350 may include a cell library database (DB) 351 and a layout DB 353. The cell library DB 351 may store information about a standard cell required to generate a layout of an integrated circuit, and may be referred to as a standard cell library DB. The layout DB 353 may store information about the layout generated in procedures, specifically, physical information about the layout. Additionally, the storage device 350 may store memory DB including library information about the memory candidate group, and may store various kinds of data related to the modules described above. For example, the storage device 350 may store timing data, synthesized data, layout data, selected memory combinations, or the like that is generated as results of the operation of the EDA tool 122.

FIG. 4 is a flowchart of a method of designing an integrated circuit, according to an embodiment.

Referring to FIG. 4, the method of designing an integrated circuit may include a plurality of operations S100 through S500. Hereinafter, FIG. 4 is described with reference to the drawings described above, and duplicate descriptions thereof are omitted.

In operation S100, the circuit design system 100 may select a memory combination constituting an integrated circuit from a memory candidate group. Operation S100 may include at least a portion of operation S20 in FIG. 1. The selection of the memory combination may also be made based on an external instruction, or a memory combination determined by an algorithm inside the circuit design system 100 may also be selected. An integrated circuit may have a high proportion of memories, and product specifications may be greatly affected depending on the configuration of the memories. Accordingly, the circuit design system 100 may be required to implement memories, by properly selecting memories constituting the integrated circuits, such that the power or size of an integrated circuit is not increased more than necessary while the integrated circuit normally operates. The selection of the memory combination may be performed considering the timing conditions, or the like, to be satisfied for the production of operable products of the required integrated circuit.

In operation S200, the circuit design system 100 may generate the TID. The TID may include timing information about an integrated circuit of the selected memory combination, and may include base data for performing the first pre-TA. The TID may include a netlist of the selected memory combination and the timing constraints. The netlist of the selected memory combination may include values related to a timing in a memory library. For example, the netlist may include a content about a timing having a minimum period of the contents describing memory performance. The timing constraints may include content related to a clock frequency, a timing condition, and a constraint, with respect to which the selected memory combination needs to operate. The timing constraints according to an embodiment may include synopsys design constraints (SDC) data.

In operation S300, the circuit design system 100 may perform the first pre-TA based on the TID and generate first result data. Operation S300 may include at least a portion of operation S30 in FIG. 1. The first pre-TA according to the embodiment may include the STA. The first pre-TA may be a portion of the first pre-simulation described above with reference to FIG. 1.

When the operation timing of a memory is equal to or greater than the timing threshold, in theory, the memory may operate normally. However, distortion in an operation period of a memory may occur due to various timing variables described above in the design process and the fabrication process. Accordingly, the operation timing of the memory may be required to be adjusted considering the timing variables so that the operation timing of a memory has a value of the timing threshold or greater. In other words, a timing margin reflecting the various variables additionally described above to the timing threshold may be considered.

The design process of an integrated circuit, in which the first pre-TA has not been performed, may perform the initial timing analysis after synthesis of the integrated circuit. When a result of the TA after synthesis shows that timing conditions have not been satisfied, new TA may need to be performed again after a new memory selection and a new synthesis process. Accordingly, to determine the final design of the integrated circuit within a limited time, it may be necessary to conservatively select a timing margin reflecting various timing variables in the design process of the integrated circuit in which the first pre-TA has not been performed. In other words, by selecting the timing margin reflecting various timing variables as proper values, the memory selection may be performed. As the conservative timing margin is considered, the types of selectable memories in the memory selection operation may be reduced. Thus, in the design process of an integrated circuit, on which the first pre-TA has not been performed, an integrated circuit may be designed by selecting a memory from among a group of memory candidates having a relatively limited option.

The circuit design system 100 according to an embodiment may perform the first pre-TA, in advance, that is an additional TA prior to the synthesis of an integrated circuit. In other words, the circuit design system 100 according to an embodiment may perform the initial TA prior to the synthesis of an integrated circuit. Accordingly, when the timing condition has not been satisfied as a result of initial TA, new TA may be performed quickly. In addition, because quick repetition is possible, the final design of an integrated circuit may be completed within a limited time even though the timing margin reflecting various timing variables is not conservatively selected. In other words, without selecting the timing margin reflecting various timing variables as unnecessarily large values, the memory selection may be performed.

In operation S400, the circuit design system 100 may determine whether the first result data satisfies the first timing condition. Operation S400 may include at least a portion of operation S30 in FIG. 1. The circuit design system 100 may generate the first result data as a result of performing the first pre-TA in operation S300. The circuit design system 100 may compare a value of the generated first result data with a value of the first timing threshold data. For a normal operation of an integrated circuit, a memory may satisfy the timing specification. For example, the operation timing of the memory must have a value of the first timing threshold data or greater considering the timing margin to operate normally. The first timing condition may include whether the first result data has a value of the first timing threshold data or greater considering the timing margin. In other words, when the first result data has a value of the first timing threshold data or greater, the circuit design system 100 may determine that the first timing condition is satisfied. In addition, when the first result data has a value less than the value of the first timing threshold data, the circuit design system 100 may determine that the first timing condition is satisfied.

When the first result data does not satisfy the first timing condition, operations S100 through S400 described above may be performed again. In other words, operations S100 through S400 may be repeatedly performed until the first result data satisfies the first timing condition. When the first result data satisfies the first timing condition, the circuit design system 100 may perform operation S500.

In operation S500, the circuit design system 100 may synthesize the integrated circuit to generate synthesized data. Operation S500 may include at least a portion of operation S40 in FIG. 1. The circuit design system 100 may perform a synthesis process of connecting logical structures based on the HDL code and the database of the selected memory. The circuit design system 100 may synthesize the HDL code with the selected memory to generate the synthesized data. The synthesized data according to the embodiment may include the gate level netlist.

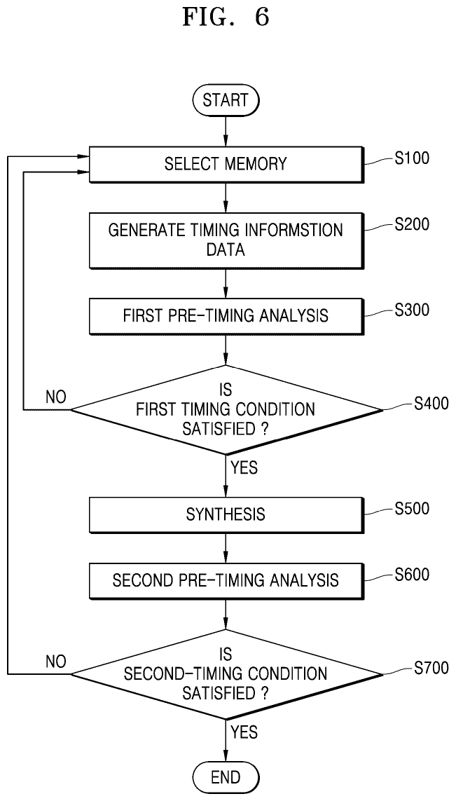

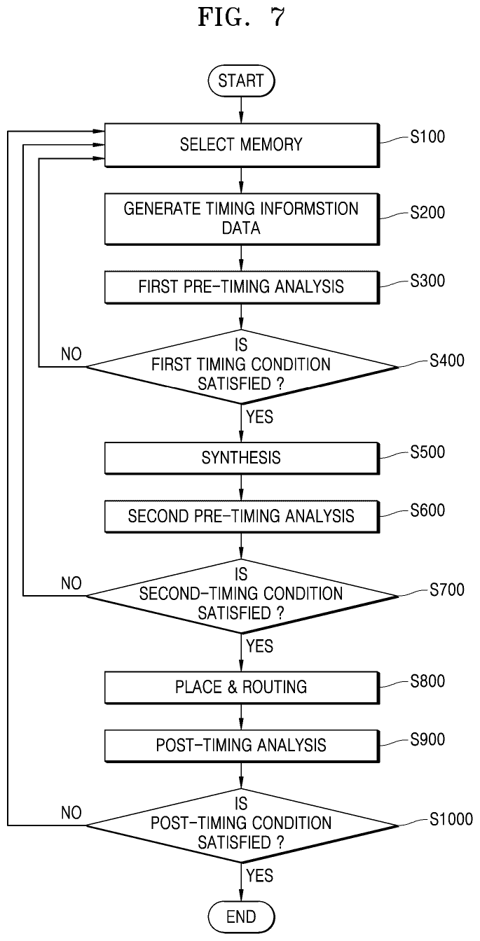

Although not illustrated, the circuit design system 100 according to the embodiment may perform additional operations after operation S500. For example, at least a portion of operations S50 through S70 in FIG. 1 may be performed. The performance of additional operations is described below with reference to FIGS. 6 and 7.

According to the embodiments described above, by additionally performing the pre-TA prior to the synthesis of an integrated circuit, the integrated circuit may be designed by quickly and efficiently selecting memories constituting the integrated circuit. In addition, by performing the TA quickly and efficiently in the memory selection operation prior to the synthesis of an integrated circuit, unnecessary timing margins may be reduced, and the performance of the integrated circuit may be increased by using quick feedback.

FIG. 5 is a flowchart of a method of designing an integrated circuit, according to an embodiment.

Referring to FIG. 5, operation S200 in FIG. 4 may include a plurality of operations S210 and S220. Hereinafter, FIG. 5 is described with reference to the drawings described above, and duplicate descriptions thereof are omitted.

In operation S210, the circuit design system 100 may load a memory database. The memory database may include library information about the selected memory combination. The memory database may be stored in the storage device 140 constituting the circuit design system 100. The circuit design system 100 may load the memory database from the storage device 140. The memory database may additionally include information about timing variables constituting the timing margin. For example, the memory database according to the embodiment may further include at least one of stability margin data, jitter margin data, and clock frequency data.

In operation S220, the circuit design system 100 may generate the TID based on the loaded memory database. The TID may include the netlist of the selected memory combination and the timing constraints. The TID may include data for the first pre-TA. During the design process of the integrated circuit, the synthesis operation may be performed by including not only a memory-related database but also databases related to all components, such as processors, buses, and intellectual properties (IPs). In other words, not only the memory, but all components, such as processor, buses, and IPs may be merged and synthesized to generate the synthesized data. In comparison, the TID may include only the minimum amount of data for performing the first pre-TA prior to performing the synthesis operation. The circuit design system 100 may generate the TID based on essential data for the TA. Thus, the time required to generate the TID may be less than the time required to generate synthesized data by using the synthesis process. The circuit design system 100 according to the embodiment may perform the first pre-TA prior to the synthesis of an integrated circuit. Accordingly, when the timing condition is not satisfied as a result of the initial TA, the TA may be performed again quickly. In addition, because quick repetition is possible, the final design of an integrated circuit may be completed within a limited time even though the timing margin reflecting various timing variables is not conservatively selected. In other words, without selecting the timing margin reflecting various timing variables as unnecessarily large values, the memory selection may be performed.

FIG. 6 is a flowchart of a method of designing an integrated circuit, according to an embodiment.

Referring to FIG. 6, the method of designing an integrated circuit may include a plurality of operations S100 through S700. Operations S100 through S500 in FIG. 6 may correspond to operations S100 through S500 of FIG. 4. Hereinafter, FIG. 6 is described with reference to the drawings described above, and duplicate descriptions thereof are omitted.

In operation S100, the circuit design system 100 may select a memory combination constituting an integrated circuit from a memory candidate group. Operation S100 may include at least a portion of operation S20 in FIG. 1.

In operation S200, the circuit design system 100 may generate the TID. The TID may include timing information on an integrated circuit of the selected memory combination, and may include base data for performing the first pre-TA.

In operation S300, the circuit design system 100 may perform the first pre-TA based on the TID and generate first result data. Operation S300 may include at least a portion of operation S30 in FIG. 1. The first pre-TA according to the embodiment may include the STA. The first pre-TA may be a portion of the first pre-simulation described above with reference to FIG. 1.

In operation S400, the circuit design system 100 may determine whether the first result data satisfies the first timing condition. Operation S400 may include at least a portion of operation S30 in FIG. 1. The circuit design system 100 may generate the first result data as a result of performing the first pre-TA in operation S300. The circuit design system 100 may compare the value of the generated first result data with the value of the first timing threshold data. When the first result data does not satisfy the first timing condition, operations S100 through S400 described above may be performed again. In other words, operations S100 through S400 may be repeatedly performed until the first result data satisfies the first timing condition. When the first result data satisfies the first timing condition, the circuit design system 100 may perform operation S500.

In operation S500, the circuit design system 100 may synthesize the integrated circuit to generate synthesized data. Operation S500 may include at least a portion of operation S40 in FIG. 1. The circuit design system 100 may perform a synthesis process of connecting logical structures based on the HDL code and the database of the selected memory. The circuit design system 100 may synthesize the HDL code with the selected memory to generate the synthesized data.

In operation S600, the circuit design system 100 may perform the second pre-TA based on the synthesized data and generate second result data. Operation S600 may include at least a portion of operation S50 in FIG. 1. The second pre-TA according to the embodiment may include the STA. The second pre-TA may be a portion of the second pre-simulation described above with reference to FIG. 1.

The design process of an integrated circuit, in which the first pre-timing analysis has not been performed, may perform the initial timing analysis after synthesis of an integrated circuit. In other words, without performing the first pre-simulation, the second pre-simulation may be performed for the first time after synthesis. The circuit design system 100 according to the embodiment may check in advance whether the integrated circuit malfunctions by using the first pre-simulation that performs the TA before synthesis of the integrated circuit in operation S300. In addition, the circuit design system 100 may check whether the integrated circuit malfunctions by performing the second pre-simulation after synthesis of the integrated circuit in operation S600.

In operation S700, the circuit design system 100 may determine whether the second result data satisfies a second timing condition. Operation S700 may include at least a portion of operation S50 in FIG. 1. The circuit design system 100 may compare the value of the second result data generated in operation S600 with the value of the second timing threshold data. For a normal operation of the integrated circuit, the memory may satisfy the timing specification. For example, the operation timing of the memory must have a value of the second timing threshold data or greater considering the timing margin to operate normally. The second timing condition may include whether the second result data has a value of the second timing threshold data or greater considering the timing margin. In other words, when the second result data has a value of the second timing threshold data or greater, the circuit design system 100 may determine that the second timing condition is satisfied. In addition, when the second result data has a value less than the value of the second timing threshold data, the circuit design system 100 may determine that the second timing condition is satisfied.

When the second result data does not satisfy the second timing condition, operations S100 through S700 described above may be performed again. In other words, operations S100 through S700 may be repeatedly performed until the second result data satisfies the second timing condition. When the second result data satisfies the second timing condition, the circuit design system 100 may terminate a process of designing an integrated circuit.

The first pre-TA according to an embodiment may include an analysis performed based on a timing condition having a smaller timing margin than the second pre-TA. That is, the first timing threshold data may have a smaller timing margin than the second timing threshold data. The circuit design system 100 according to the embodiment may perform the first pre-TA prior to the synthesis of an integrated circuit. Accordingly, when the timing condition is not satisfied as a result of the first pre-TA, the first pre-TA may be performed again quickly. In addition, because quick repetition is possible, the final design of an integrated circuit may be completed within a limited time even though the timing margin reflecting various timing variables is not conservatively selected. In other words, in the first pre-TA, the memory selection operation may be performed without unnecessarily selecting the timing margin as a large value compared to the second pre-timing analysis. On the other hand, the circuit design system 100 may perform the second pre-TA after synthesis of the integrated circuit. When the second timing conditions are not satisfied as a result of the second pre-TA after the synthesis, the second pre-TA may be performed again after the memory selection process and the synthesis process. Accordingly, to determine the final design of the integrated circuit within a limited time, it may be necessary for the circuit design system 100 to conservatively select the timing margin in the second pre-timing analysis. In other words, by selecting the timing margin reflecting various timing variables as proper values, the memory selection operation may be performed.

Although not illustrated, the circuit design system 100 according to an embodiment may perform additional operations after operation S700. For example, at least a portion of operations S60 and S70 in FIG. 1 may be performed. The performance of additional operations is described below with reference to FIG. 7.

According to the embodiments described above, by additionally performing the pre-timing analysis prior to the synthesis of an integrated circuit, the integrated circuit may be designed by quickly and efficiently selecting memories constituting the integrated circuit. In addition, by performing the TA quickly and efficiently in the memory selection operation prior to the synthesis of an integrated circuit, unnecessary timing margins may be reduced, and the performance of the integrated circuit may be increased by using quick feedback.

FIG. 7 is a flowchart of a method of designing an integrated circuit, according to an embodiment.

Referring to FIG. 7, the method of designing an integrated circuit may include a plurality of operations S100 through S1000. Operations S100 through S500 in FIG. 7 may correspond to operations S100 through S500 of FIG. 4. In addition, operations S100 through S700 in FIG. 7 may correspond to operations S100 through S700 in FIG. 6. Hereinafter, FIG. 6 is described with reference to the drawings described above, and duplicate descriptions thereof are omitted.

In operation S100, the circuit design system 100 may select a memory combination constituting an integrated circuit from a memory candidate group. Operation S100 may include at least a portion of operation S20 in FIG. 1.

In operation S200, the circuit design system 100 may generate the TID. The TID may include timing information in an integrated circuit of the selected memory combination, and may include base data for performing the first pre-TA.

In operation S300, the circuit design system 100 may perform the first pre-TA based on the TID and generate first result data. Operation S300 may include at least a portion of operation S30 in FIG. 1. The first pre-TA according to the embodiment may include the STA. The first pre-TA may be a portion of the first pre-simulation described above with reference to FIG. 1.

In operation S400, the circuit design system 100 may determine whether the first result data satisfies the first timing condition. Operation S400 may include at least a portion of operation S30 in FIG. 1. The circuit design system 100 may generate the first result data as a result of performing the first pre-TA in operation S300. The circuit design system 100 may compare a value of the generated first result data with a value of first timing threshold data. When the first result data does not satisfy the first timing condition, operations S100 through S400 described above may be performed again. In other words, operations S100 through S400 may be repeatedly performed until the first result data satisfies the first timing condition. When the first result data satisfies the first timing condition, the circuit design system 100 may perform operation S500.

In operation S500, the circuit design system 100 may synthesize the integrated circuit to generate synthesized data. Operation S500 may include at least a portion of operation S40 in FIG. 1. The circuit design system 100 may perform a synthesis process of connecting logical structures based on the HDL code and the database of the selected memory. The circuit design system 100 may synthesize the HDL code with the selected memory to generate the synthesized data.

In operation S600, the circuit design system 100 may perform the second pre-TA based on the synthesized data and generate the second result data. Operation S600 may include at least a portion of operation S50 in FIG. 1. The second pre-TA according to the embodiment may include the STA. The second pre-TA may be a portion of the second pre-simulation described above with reference to FIG. 1.

In operation S700, the circuit design system 100 may determine whether the second result data satisfies the second timing condition. Operation S700 may include at least a portion of operation S50 in FIG. 1. The circuit design system 100 may compare the value of the second result data generated in operation S600 with the value of the second timing threshold data. When the second result data does not satisfy the second timing condition, operations S100 through S700 described above may be performed again. In other words, operations S100 through S700 may be repeatedly performed until the second result data satisfies the second timing condition. When the second result data satisfies the second timing condition, the circuit design system 100 may perform operation S800.

In operation S800, the circuit design system 100 may perform the P&R on the synthesized data to generate P&R data. Operation S800 may include at least a portion of operation S60 in FIG. 1. The circuit design system 100 may implement a layout by arranging actual devices and connecting wirings, based on the synthesized data that has undergone through a second pre-simulation. The layout to be implemented may be implemented in two dimensions (2D) or 3D. The P&R process may include designing of a layout to be drawn on a wafer or a layout of a PCB substrate. Operation S800 may also be performed outside. For example, operation S800 may also be performed by a company such as a design house. In operation S800, the circuit design system 100 may generate the P&R data as a result of the P&R process. The P&R data may include layout data, and the P&R data according to an embodiment may include a GDS file.

In operation S900, the circuit design system 100 may perform post-TA based on the P&R data. Operation S900 may include at least a portion of operation S70 in FIG. 1. Apart from the first pre-TA and the second pre-TA performed in the front-end design operation, the TA performed on the P&R data generated in the back-end design operation may be referred to as the post-TA. Operation S900 may also be performed outside. For example, operation S900 may also be performed by a company such as a design house.

In operation S1000, the circuit design system 100 may determine whether post result data satisfies a post timing condition. Operation S1000 may include at least a portion of operation S70 in FIG. 1. The circuit design system 100 may compare a value of the P&R data generated in operation S900 with a value of post timing threshold data. For a normal operation of an integrated circuit, the memory may satisfy the timing specification. For example, the operation timing of the memory must have a value of the post timing threshold data or greater considering the timing margin to operate normally. The post timing condition may include whether the post result data has a value of the second timing threshold data or greater considering the timing margin. In other words, when the post result data has a value of the second timing threshold data or greater, the circuit design system 100 may determine that the post timing condition is satisfied. In addition, when the post result data has a value less than the value of the second timing threshold data, the circuit design system 100 may determine that the post timing condition is not satisfied.

When the post result data does not satisfy the post timing condition, operations S100 through S1000 described above may be performed again. In other words, according to the embodiment, operations S100 through S1000 may be repeatedly performed until the post result data satisfies the post timing condition. When the post result data satisfies the post timing condition, the circuit design system 100 may terminate a process of designing an integrated circuit.

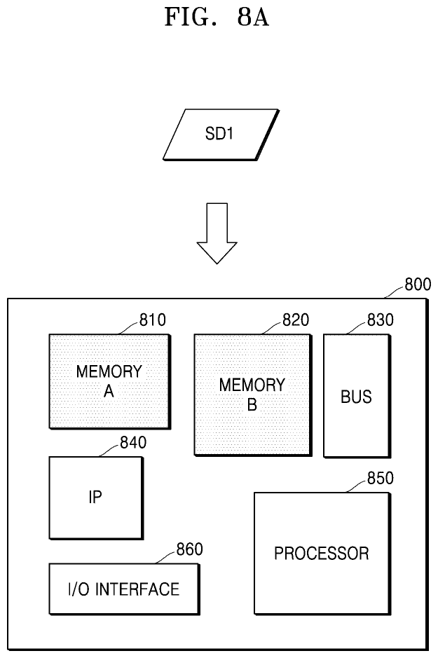

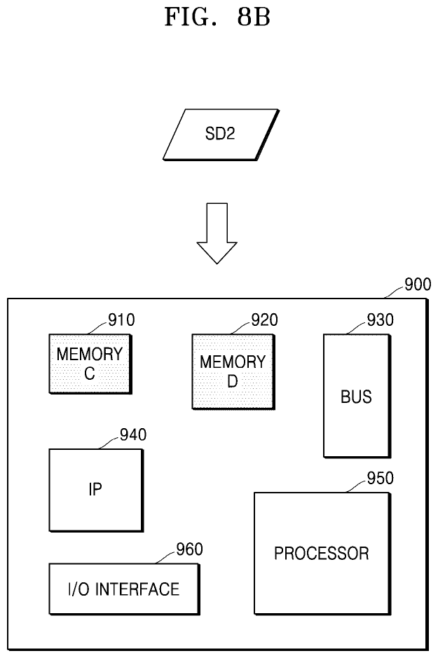

FIGS. 8A and 8B are block diagrams of integrated circuits 800 and 900 fabricated according to the synthesized data, according to embodiments, respectively.

FIG. 8A illustrates the shape of the integrated circuit 800 fabricated corresponding to first synthesized data SD1, when the synthesized data output by the circuit design system 100 is the first synthesized data SD1. FIG. 8B illustrates the shape of the integrated circuit 900 fabricated corresponding to second synthesized data SD2, when the synthesized data output by the circuit design system 100 is the second synthesized data SD2.

Referring to FIG. 8A, the circuit design system 100 may generate the first synthesized data SDI as a result of performing the method of designing an integrated circuit described above. The circuit design system 100 may generate the first synthesized data SDI by finally selecting a memory group including a memory A 810 and a memory B 820 from among the memory candidate group. Based on the first synthesized data SD1, thereafter, the first integrated circuit 800 may be fabricated by performing the layout data manufacturing process. The first integrated circuit 800 according to the embodiment may include the memory A 810, the memory B 820, a bus 830, an IP 840, a processor 850, and an I/O interface 860.

Referring to FIG. 8B, the circuit design system 100 according to the embodiment may generate the second synthesized data SD2 as a result of performing the method of designing an integrated circuit described above. The circuit design system 100 may generate the second synthesized data SD2 by finally selecting a memory group including a memory C 910 and a memory D 920 from among the memory candidate group. Based on the second synthesis data SD2, layout data may be generated, and the second integrated circuit 900 may be fabricated by performing the fabrication process. The second integrated circuit 900 according to the embodiment may include the memory C 910, the memory D 920, a bus 930, an IP 940, a processor 950, and an I/O interface 960.

The second integrated circuit 900 may be fabricated based on a memory group including memories that are different from memories of the first integrated circuit 800. FIG. 8A illustrates the first integrated circuit 800, which is finally generated without performing the first pre-TA, and FIG. 8B illustrates the second integrated circuit 900, which is finally generated by performing the first pre-TA, according to embodiments. The circuit design system 100 may generate the second synthesized data SD2 by selecting memories relatively quickly and efficiently compared to the first synthesized data SD1 by using the first pre-TA. The first synthesized data SDI may include data generated without performing the first pre-TA. Accordingly, even with the same performance, the size or power of the memory constituting the second integrated circuit 900 corresponding to the second synthesized data SD2 may be less than the size or power of the memory constituting the first integrated circuit 800 corresponding to the first synthesized data SD1.

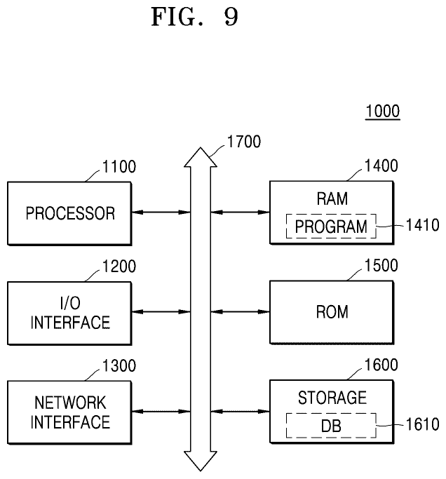

FIG. 9 is a block diagram of a computing system 1000 including memories for storing programs according to an embodiment.

At least some of the operations constituting the method of designing an integrated circuit may be performed by the computer system 1000. In some embodiments, the computing system 1000 may be referred to as a system for designing an integrated circuit.

The computing system 1000 may include a fixed computing system, such as a desktop computer, a workstation, and a server, or may also include a portable computing system such as a laptop computer. As illustrated in FIG. 9, the computing system 1000 may include a processor 1100, I/O interfaces 1200, a network interface 1300, RAM 1400, ROM 1500, and a storage 1600. The processor 1100, the I/O interfaces 1200, the network interface 1300, the RAM 1400, the ROM 1500, and the storage device 1600 may be connected to a bus 1700, and may communicate with each other via the bus 1700.

The processor 1100 may be referred to as a processing unit, and may include at least one core, such as a micro-processor, an AP, a DSP, and a GPU, which are capable of executing various sets of instructions (for example, IA-32, 64-bit extensions to IA-32, x86-64, PowerPC, SPARC, MIPS, ARM, IA-64, etc.). For example, the processor 1100 may access a memory, that is, the RAM 1400 or the ROM 1500, via the bus 1700, and may execute commands stored in the RAM 1400 or the ROM 1500.

The RAM 1400 may store a program 1410 for designing an integrated circuit or at least a portion thereof, and the program 1410 may control the processor 1100 to perform at least some of the operations constituting the method of designing an integrated circuit. In other words, the program 1410 may include a plurality of instructions executable by the processor 1100, and the plurality of instructions included in the program 1410 may control the processor 1100 to perform at least some of the operations included in the method described above.

The storage 1600 may not lose stored data even when the power supplied to the computing system 1000 is cut off. For example, the storage 1600 may also include a non-volatile memory device, and may also include a storage medium, such as a magnetic tape, an optical disk, and a magnetic disk. In addition, the storage 1600 may also be detachable from the computing system 1000. The storage 1600 may store the program 1410 according to the embodiment, and before the program 1410 is executed by the processor 1100, the program 1400_1 or at least a portion of the program 1410 or at least a portion thereof may be loaded in the RAM 1400 from the storage 1600. Alternatively, the storage 1600 may store a file written in a program language, and the program 1410 generated from a file by a compiler or the like, or at least a portion of the program 1410 may be loaded in the RAM 1400. In addition, as illustrated in FIG. 13, the storage 1600 may store a database (DB) 1610, and the DB 1610 may include information necessary to perform a method for a hybrid model, for example, sample data.

The storage 1600 may store data to be processed by the processor 1100 or may also store data processed by the processor 1100. In other words, the processor 1100 may generate data by processing data stored in the storage 1600 according to the program 1410, and may also store the generated data in the storage 1600.

The I/O interfaces 1200 may include an input device, such as a keyboard and a pointing device, and may include an output device, such as a display device and a printer. For example, a user may trigger execution of the program 1410 by using the processor 1100 via the I/O interfaces 1200, may also input training data, and may check result data.

The network interface 1300 may provide an access to a network outside the computing system 1000. For example, the network may include a plurality of computing systems and communication links, and the communication links may include wired links, optical links, wireless links, or any other types of links.

According to the embodiments described above, by additionally performing the pre-TA prior to the synthesis of the integrated circuit, it may be possible to design an integrated circuit by quickly and efficiently selecting memories constituting the integrated circuit. In addition, by performing the TA quickly and efficiently in the memory selection operation prior to the synthesis of the integrated circuit, unnecessary timing margins may be reduced, and the performance of the integrated circuit may be increased by using quick feedback.

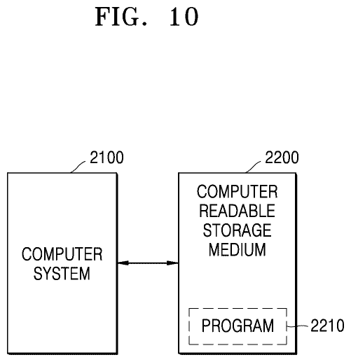

FIG. 10 is a block diagram of a computer system 2100 accessing a computer-readable storage medium 2200 according to an embodiment.

At least some of the operations of modeling characteristics of a target semiconductor device and generating a circuit model may be performed by the computer system 2100. The computer system 2100 may access a computer-readable storage medium 2200, and execute a program 2210 stored in the computer-readable storage medium 2200. In the embodiment, the computer system 2100 and the computer-readable storage medium 2200 may be collectively referred to as a system for modeling the characteristics of the target semiconductor device.

The computer system 2100 may include at least one computer subsystem, and may include at least one component executed by the at least one computer subsystem. For example, the at least one component may include machine learning models described above with reference to the drawings, and may include a model trainer training a machine learning model or modifying the machine learning model. Similar to the storage 1600 in FIG. 9, the computer-readable storage medium 2200 may also include a non-volatile memory device, or a storage medium, such as a magnetic tape, an optical disk, and a magnetic disk. In addition, the computer-readable storage medium 2200 may be detachable from the computer system 2100.

While the inventive concept has been particularly shown and described with reference to embodiments thereof, it will be understood that various change in form and details may be made therein without departing from the spirit and scope of the following claims.

What is claimed is:

1. A method of designing an integrated circuit by using a computing system, the method comprising:
selecting a memory combination from among a memory candidate group;
generating timing information data of the selected memory combination;
generating first result data by performing a first pre-timing analysis module based on the timing information data;
determining whether the first result data satisfies a first timing condition; and
when the first result data satisfies the first timing condition, generating synthesized data by synthesizing the integrated circuit.

2. The method of claim 1, wherein,
when the first result data does not satisfy the first timing condition,
the selecting of the memory combination, the generating of the timing information data, the generating of the first result data, and the determining whether the first timing condition is satisfied are performed again.

3. The method of claim 1, further comprising:
generating second result data by performing a second pre-timing analysis based on the synthesized data; and
determining whether the second result data satisfies a second timing condition.

4. The method of claim 3, wherein,
when the second result data satisfies the second timing condition, generating placement and routing (P&R) data by performing the P&R operation on the synthesized data, and
performing a post-timing analysis based on the P&R data are performed again.

5. The method of claim 3, wherein,
when the second result data does not satisfy the second timing condition,
the selecting of the memory combination, the generating of the timing information data, the generating of the first result data, the determining whether the first timing condition is satisfied, the generating of the second result data, and determining whether the second timing condition is satisfied are performed again.

6. The method of claim 3, wherein the first timing condition has a smaller timing margin than the second timing condition.

7. The method of claim 1, wherein
the timing information data comprises
at least one of a netlist of the memory combination and timing constraints, and
the synthesized data comprises a gate level netlist.

8. The method of claim 1, wherein
the generating of the timing information data comprises:
loading a memory database including library information of the selected memory combination; and
generating the timing information data based on the memory database.

9. The method of claim 8, wherein the memory database further comprises at least one of reliability margin data, jitter margin data, and clock frequency data.

10. The method of claim 1, wherein the first pre-timing analysis comprises a static timing analysis (STA).

11. A system for designing an integrated circuit, the system comprising:
at least one processor; and
a non-transitory storage medium for storing instructions, which when executed by the at least one processor, cause the at least one processor to execute designing an integrated circuit,
wherein the designing of the integrated circuit comprises:
selecting a memory combination from among a memory candidate group;
generating timing information data of the selected memory combination;
generating first result data by performing a first pre-timing analysis module based on the timing information data;
determining whether the first result data satisfies a first timing condition; and
when the first result data satisfies the first timing condition, generating synthesized data by synthesizing the integrated circuit.

12. The system of claim 11, wherein,
when the first result data does not satisfy the first timing condition,
the selecting of the memory combination, the generating of the timing information data, the generating of the first result data, and the determining whether the first timing condition is satisfied are performed again.

13. The system of claim 11, further comprising:
generating second result data by performing a second pre-timing analysis based on the synthesized data; and
determining whether the second result data satisfies a second timing condition.

14. The system of claim 13, further comprising:
when the second result data satisfies the second timing condition, generating placement and routing (P&R) data by performing the P&R operation on the synthesized data and
performing a post-timing analysis based on the P&R data are performed again.

15. The system of claim 13, wherein,
when the second result data does not satisfy the second timing condition,
the selecting of the memory combination, the generating of the timing information data, the generating of the first result data, the determining whether the first timing condition is satisfied, the generating of the second result data, and determining whether the second timing condition is satisfied are performed again.

16. The system of claim 13,
wherein the first timing condition has a smaller timing margin than the second timing condition.

17. The system of claim 11, wherein
the timing information data comprises
at least one of a netlist of the memory combination and timing constraints, and
the synthesized data comprises a gate level netlist.

18. The system of claim 11, wherein
the generating of the timing information data comprises:
loading a memory database including library information of the selected memory combination; and
generating the timing information data based on the memory database.

19. A non-transitory storage medium for storing instructions, which when executed by the at least one processor, cause the at least one processor to execute designing an integrated circuit,
wherein the designing of the integrated circuit comprises:
selecting a memory combination from among a memory candidate group;
generating timing information data of the selected memory combination;
generating first result data by performing a first pre-timing analysis module based on the timing information data;
determining whether the first result data satisfies a first timing condition; and
when the first result data satisfies the first timing condition, generating synthesized data by synthesizing the integrated circuit.

20. The non-transitory storage medium of claim 19, wherein,
when the first result data does not satisfy the first timing condition,
the selecting of the memory combination, the generating of the timing information data, the generating of the first result data, and the determining whether the first timing condition is satisfied are performed again.
